(19) United States
(12) Patent Application Publication
(10) Pub. No.: US 2023/0337633 A1
(43) Pub. Date: Oct. 26, 2023

(54) Excrement collecting apparatus

(71) Applicant: Delbert Beaupierre, Chandler, AZ (US)

(72) Inventor: Delbert Beaupierre, Chandler, AZ (US)

(21) Appl. No.: 17/660,760

(22) Filed: Apr. 26, 2022

(51) Int. Cl. A01K 23/00

(52) U.S. Cl. CPC A01K 23/00

(57) ABSTRACT

An excrement collecting apparatus for collecting excrement as produced by a dog or other animal. Said excrement collecting apparatus consists of a harness and an excrement bag assembly. The excrement bag assembly may be reusable or disposable. The entire excrement collecting apparatus may be reusable or disposable. The harness consists of at least two side straps, a lower strap, and a lower back harness strap. The excrement bag assembly is fixedly or removably attached to the lower strap and side straps. A weak adhesive is used to attach a side of the excrement bag to the lower strap so that the excrement bag is held out of the way when it is not filled with excrement, thus allowing an animal to be more comfortable. The weak adhesive allows the excrement bag to release and hang freely when it is filled with excrement.

### TECHNICAL FIELD

The present invention relates generally to the field of pet care products and more specifically to the field of defecation collection devices.

### BACKGROUND

The following is a tabulation of some prior art that presently appears relevant:

U.S. Patents

| Patent Number | Kind Code | Issue Date | Patentee |
|---|---|---|---|
| U.S. Pat. No. 6,394,041 | B1 | May 28, 2002 | Katz |
| U.S. Pat. No. 10,918,088 | B2 | Feb. 16, 2021 | Tutu |

U.S. Patent Publications

| Publication Number | Kind Code | Date | Applicant |
|---|---|---|---|
| US 2007/0199523 | A1 | Aug. 30, 2007 | Arcos Quinones et al. |
| US 2015/0034023 | A1 | Feb. 5, 2015 | Tseng |

Dogs are in high demand as pets, but along with dog ownership comes the problem of dealing with dog feces. Dog feces are not only an eyesore, but they can pose a public health concern when the feces are not cleaned up sufficiently and consistently. Dog excrement can pose a risk of infection and parasites.

Currently, dog owners must stoop to pick up their pet's excrement and clean up with a plastic bag, which is not desirable because some of the excrement is inevitably left behind. In the prior art there are devices to catch excrement, but these devices are complicated to use and difficult for the pet to wear. There is no product currently available that is able to fulfill the needs of pet owners in a practical, simple, effective and marketable manner.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

In order to fulfill the needs of pet owners in a practical, simple, effective and marketable manner, this invention shows a novel way to collect excrement in a disposable bag. This invention uses an excrement bag assembly which is attached to a pet's tail and anal region with straps that secure the assembly to a pet's body. The excrement collecting apparatus has a weak adhesive which connects the excrement bag to a lower strap and keeps the bag out of the way when there is no excrement in the excrement bag. The excrement bag assembly may be fully disposable and may be attached to the harness by hook and loop adhesive such as Velcro™, buttons, or other appropriate attachment methods. Alternatively, the excrement bag assembly may be reusable and only a bag from the assembly may be disposed of.

The excrement collecting apparatus could be used at private residences, outdoors, or any area where it is inappropriate to defecate. The excrement collecting apparatus is useful for dogs in public spaces but is not limited to dogs or public spaces. The excrement collecting apparatus could be adapted for any quadruped such as horses and cattle.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

Advantages

Accordingly several advantages of one or more aspects are as follows: the excrement collecting apparatus has a simple excrement bag assembly which is either totally disposable or disposable in part. The excrement collecting apparatus is fitted to a dog's body and is adjustable and can be easily produced in many different sizes. The excrement collecting apparatus is adaptable for other animals such as horses and cattle. The excrement collecting apparatus is useful in any public areas or in residences. The excrement collecting apparatus allows an excrement bag to be removably attached to a lower harness strap which keeps the excrement bag out of the way when empty and allows the excrement bag to swing freely when full of feces.

### BRIEF DESCRIPTION OF THE DRAWINGS

The accompanying drawings, which are incorporated in and constitute a part of this disclosure, illustrate various embodiments of the present disclosure. Furthermore, the drawings may contain text or captions that may explain certain embodiments of the present disclosure. This text is included for illustrative, non-limiting, explanatory purposes of certain embodiments detailed in the present disclosure.

FIG. 1 generally shows a view of the harness and excrement bag assembly as shown on a dog's posterior.

FIG. 2 generally shows a front view of an excrement bag assembly without a bag, as attached to upper straps and lower strap.

FIG. 3 generally shows a back view of an excrement bag assembly without a bag, as attached to upper straps and lower strap with hook and loop adhesive such as Velcro™.

FIG. 4 generally shows a front view of an excrement bag assembly with a bag fixedly attached.

FIG. 5 generally shows a disposable bag for use with an excrement bag assembly.

### DETAILED DESCRIPTION

As a preliminary matter, it will be readily understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure.

Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

While embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

It is intended that the scope of patent protection is to be defined by the issued claim(s) rather than the description set forth herein. Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While multiple embodiments of the disclosure may be described, modifications, adaptations, and other implementations are possible. For example, substitutions, additions, or modifications may be made to the elements illustrated in the drawings. Accordingly, the following detailed description does not limit the disclosure. Instead, the proper scope of the disclosure is defined by the appended claims.

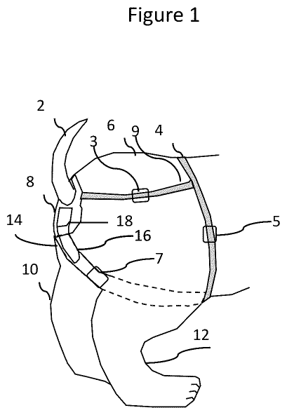

FIG. 1 shows a view an excrement collecting apparatus as shown on a dog's posterior 6. The excrement collecting apparatus consists of an excrement bag assembly 8 and a harness assembly. A dog's posterior is shown, but an excrement collecting apparatus could be used for any quadruped animal such as a cow or a horse.

A harness assembly in FIG. 1 is composed of at least one lower back harness strap 4. The lower back harness strap 4 is made of nylon, cotton, elastic, rubber, leather, or other strapping material which may be reusable or disposable. The lower back harness strap 4 is a full loop around an abdomen of an animal. The lower back harness strap 4 is adjustable using a known method such as a slide buckle 5. A harness assembly is further composed of at least two upper straps 9 are generally horizontally on a right and a left side of an animal's body and connect to the lower back harness strap 4. The upper straps 9 are made of nylon, cotton, elastic, rubber, leather, or other strapping material which may be reusable or disposable. The upper straps 9 are adjustable using a known method such as a slide buckle 3. A harness assembly is further comprised of at least one lower strap 14 which goes between an animal's legs 12 and connects to the lower back harness strap 4. The lower strap 14 is made of nylon, cotton, elastic, rubber, leather, or other strapping material which may be reusable or disposable. The lower strap 14 is adjustable using a known method such as a slide buckle 7. The harness assembly may be produced in many different sizes to accommodate various sizes of dogs or other animals.

An excrement bag assembly 8 surrounds the dog's tail 2 and anal region 18. The excrement bag assembly 8 could be made of plastic, cardboard, rubber, silicone, or any other disposable or reusable material. The excrement bag assembly 8 may be fixedly or removably attached to an excrement storage bag 16, in which case the excrement bag assembly 8 may be removably attached to the harness assembly upper straps 9 and the lower strap 14. The excrement bag assembly 8 may be disposable or reusable. The excrement collecting assembly may be disposable or reusable.

In alternative embodiments, an excrement bag assembly may be removably attached to an excrement bag 16, in which case the excrement bag assembly 8 may be removably attached to the upper straps 9 and the lower strap 14. This removable attachment may be accomplished by using hook and loop adhesive such as Velcro™, buttons, buckles, or other attachment methods. The excrement bag assembly 8 may be disposable or reusable. The excrement collecting assembly may be disposable or reusable.

An excrement bag 16 is removably attached to the lower strap using a weak adhesive such as a low-sticky type glue tape which uses a weak adhesive material of the actylic acid ester resin which can adjust its adhesion according to the thickness of the glue layer. Other weak adhesives as known in the prior art may also be used. This removable attachment of the excrement bag keeps the excrement bag 16 out of the way when it is empty and allows the excrement bag 16 to swing freely when it is full of feces.

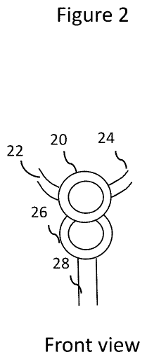

FIG. 2 generally shows a front view of an excrement bag assembly without a bag, as attached to upper straps 22 and 24 and lower strap 28. An excrement bag assembly consists of a tail loop 20 which goes around an animal's tail, and a lower loop 26 which goes around an animal's anal region. A lower strap 28 is fixedly or removably attached to the lower loop 26. A right upper strap 24 is fixedly or removably attached to the excrement bag assembly. A left upper strap 22 is fixedly or removably attached to the excrement bag assembly.

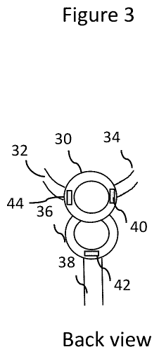

FIG. 3 generally shows a back view of an excrement bag assembly without a bag, as attached to upper straps and lower strap with hook and loop adhesive such as Velcro™. An excrement bag assembly consists of a tail loop 30 which goes around an animal's tail, and a lower loop 36 which goes around an animals anal region. A lower strap 38 is removably attached to the lower loop 30 using a Velcro™ strip 42. A right upper strap 34 is removably attached to the tail loop 30 using a Velcro™ strip 40. A left upper strap 32 is removably attached to the tail loop 30 using a Velcro™ strip 44. This representation is merely one method of attachment and the Velcro™ strips could be replaced with other hook and loop adhesives, buttons, buckles, or other suitable methods of attachment.

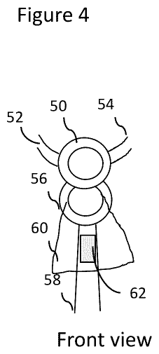

FIG. 4 generally shows a front view of an excrement bag assembly with an excrement bag fixedly attached. An excrement bag assembly consists of a tail loop 50 which goes around an animal's tail, and a lower loop 56 which goes around an animal's anal region. A lower strap 58 is fixedly or removably attached to the lower loop 56. A right upper strap 54 is fixedly or removably attached to the excrement bag assembly. A left upper strap 52 is fixedly or removably attached to the excrement bag assembly. An excrement bag 60 is fixedly or removably attached to the lower loop 56. The excrement bag is removably attached to lower strap 58 with weak adhesive such as a low-sticky type glue tape which uses a weak adhesive material of the acrylic acid ester resin which can adjust its adhesion according to the thickness of the glue layer. Other weak adhesives as known in the prior art may also be used. This removable attachment of the excrement bag keeps the excrement bag 60 out of the way when it is empty and allows the excrement bag 60 to swing freely when it is full of feces. The excrement bag may be fixedly attached to the lower loop 56 by use of an adhesive which is strong enough to hold the excrement bag 60 to the lower loop 56. The excrement bag 60 may be removably attached to the lower loop 56 by inserting the excrement bag 60 through the lower loop 56 or by use of hook and loop adhesive such as Velcro™ or other known attachment mechanism.

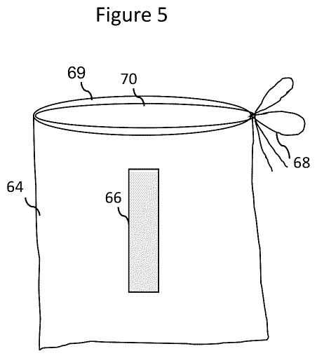

FIG. 5 generally shows an excrement bag 64 for use with an excrement bag assembly. The excrement bag 64 is of a size sufficient to store an animal's excrement, and its size may vary with the size of a dog or other animal. The excrement bag 64 may be made of plastic or biodegradable plastic or any other suitable material. An excrement bag 64 may be disposable. An excrement bag 64 may have a drawstring 68 or other closure device. An excrement bag 64 has an opening 70 and an outside edge 69. The excrement bag 64 has a strip of weak adhesive 66 on the side of the bag for attaching it to a lower strap. The excrement bag 16 is removably attached to the lower strap using a weak adhesive such as a low-sticky type glue tape which uses a weak adhesive material of the acrylic acid ester resin which can adjust its adhesion according to the thickness of the glue layer. Other weak adhesives as known in the prior art may also be used. This removable attachment of the excrement bag 64 keeps the excrement bag 64 out of the way when it is empty and allows the excrement bag 64 to swing freely when it is full of feces.

Although the preferred embodiments of the present invention have been shown and described, it will be readily apparent to those skilled in the art that modifications may be made thereto which do not exceed the scope of the appended claims. Therefore, the scope of the invention is only to be limited by the following claims.

I claim:

1. An excrement collecting apparatus consisting of an excrement bag assembly connected to a harness, said excrement bag assembly consisting of a tail loop and a lower loop, said tail loop connected to at least two upper straps, said lower loop connected to at least one lower strap, said upper straps and said lower strap connected to at least one lower back harness strap, and said lower loop is attached to an excrement bag.

2. The excrement collecting apparatus of claim 1 wherein the excrement bag is removably attached to the lower strap.

3. The excrement collecting apparatus of claim 1 wherein the excrement bag is fixedly attached to the excrement bag assembly and said excrement bag assembly is disposable.

4. The excrement collecting apparatus of claim 1 wherein the excrement bag is removably attached to the excrement bag assembly and said excrement bag assembly is reusable.

5. The excrement collecting apparatus of claim 1 wherein said harness is adjustable.
